(19) United States
(12) Patent Application Publication
(10) Pub. No.: US 2007/0276552 A1
(43) Pub. Date: Nov. 29, 2007

(54) Underwater crawler vehicle having search and identification capabilities and methods of use

(76) Inventors: Donald Rodocker, San Diego, CA (US); Jesse Rodocker, San Diego, CA (US)

Correspondence Address: LUCE, FORWARD, HAMILTON & SCRIPPS LLP, 11988 EL CAMINO REAL, SUITE 200, SAN DIEGO, CA, 92130, US

(21) Appl. No.: 11/710,013

(22) Filed: Feb. 22, 2007

Related U.S. Application Data
(60) Provisional application No. 60/776,320, filed on Feb. 24, 2006.

(51) Int. Cl. B62D 57/00

(52) U.S. Cl. 701/2; 114/337

(57) ABSTRACT

Apparatus for inspecting a submerged object and methods of use are provided, wherein a crawler vehicle includes a vortex generator, traction system and sensor system. Data from the sensor system is communicated to an onboard console for real-time review or transmission via a communication link to a remote site for analysis and review. Automated comparisons of current inspection data against normative or historical data may be performed, so in depth review of the current inspection is triggered only when the difference between current inspection data and the normative or historical data exceeds a predetermined threshold. Additionally, an adapter is provided having a vortex generator and a traction system, the adapter configured to be coupled to an ROV or other device having a sensor system.

### FIELD OF THE INVENTION

The present invention relates to apparatus and methods for searching or inspecting the hull of a ship or other vessel or submerged structure to identify foreign objects, damage, or areas requiring maintenance. The searching and identification may be conducted whether the vessel is stationary or underway.

### BACKGROUND OF THE INVENTION

Ship hull inspections may be performed for a variety of reasons. For example, it may be desirable to examine the hull of a vessel that is arriving from a foreign country to ensure that no contraband is attached. Likewise, it may be desirable to examine a hull to locate signs of tampering after leaving a foreign port. Additionally, hull examinations may be desirable as a part of routine maintenance activities, for example, to identify damage, corrosion, or areas requiring maintenance or repair.

Traditionally, exterior hull inspections have been performed by divers, because a diver may be familiar with the underwater configuration of a particular vessel, and he or she may be capable of quickly identifying changes to the vessel. Such traditional methods, however, have a number of drawbacks. For example, divers attempting to inspect the hull of a moored vessel may face obstacles such as contending with surge, difficult environmental conditions, interaction with other vessels that may be active in the area, and the general risks inherent in any diving activity.

In addition to the risks faced by divers, the duration of a hull inspection period may be limited by the physical endurance of the diver and/or the environmental conditions, such as water temperature, encountered during the dive. The presence of sediment or other particulate matter in the water also may obscure visibility, thereby further limiting the effectiveness or duration of the inspection. Moreover, divers typically are unable to inspect the hull of a ship that is underway.

More recently, remotely operated vehicles (ROV) have been used to perform hull inspections without some of the risks and limitations associated with the use of divers. However, previously known ROVs present new and different challenges, when used for ship inspection, than those associated with divers. For example, previously-known ROVs may be relatively large and unable to access locations that are accessible by divers, such as spaces between a ship and a pier to which it is moored. The relatively complicated umbilical cords used with previously known ROVs also limit the maneuverability of such devices. And ROVs generally are not capable of inspecting a ship that is underway due to inability to keep pace with the ship.

Yet other disadvantages of previously known ROVs is that they operate at relatively slow speeds and generally must be controlled in real-time by a highly skilled operator. For example, previously known ROV designs use propellers, impellers or thrusters to “swim” around the hull of a ship under direct control of a trained operator who uses real-time video guidance provided by -a camera onboard the ROV.

In view of the foregoing, it would be desirable to provide apparatus and methods of examining the hull of a ship without requiring the services of a diver.

It further would be desirable to provide apparatus and methods of examining the hull of a ship while the ship is underway.

It also would be desirable to provide apparatus and methods of examining the hull of a ship that permits the inspection to be conducted in relatively inhospitable environmental conditions, such as cold or murky water having minimal visibility.

It would be desirable to provide apparatus and methods of examining the hull of a ship wherein the inspection may be performed without requiring real-time monitoring or control by a human operator.

It also would be desirable to provide apparatus and methods of examining the hull of a ship wherein the hull topography may be transmitted to and stored in a database for comparison with subsequent inspections.

It still further would be desirable to provide apparatus and methods of examining the hull of a ship using at least a semi-automated inspection strategy based on a previously acquired hull topography.

### SUMMARY OF THE INVENTION

In view of the above-listed disadvantages of the prior art, it is an object of the present invention to provide apparatus and methods of examining the hull of a ship without requiring the services of a diver.

It is another object of this invention to provide apparatus and methods of examining the hull of a ship while the ship is underway.

It is also an object of the present invention to provide apparatus and methods of examining the hull of a ship that permits the inspection to be conducted in relatively inhospitable environmental conditions, such as cold or murky water having minimal visibility.

It is a further object of this invention to provide apparatus and methods of examining the hull of a ship wherein the inspection may be performed without requiring real-time monitoring or control by a human operator.

It is another object of this invention to provide apparatus and methods of examining the hull of a ship wherein the hull topography may be transmitted to and stored in a database for comparison with subsequent inspections.

It is a yet further object of the present invention to provide apparatus and methods of examining the hull of a ship using at least a semi-automated inspection strategy based on a previously acquired hull topography.

These and other advantages may be accomplished by providing an underwater crawler vehicle configured to traverse the exterior of the hull of a ship to detect foreign objects, damage, or areas requiring repair or maintenance. The vehicle of the present invention preferably includes a vortex generator that enables the vehicle to remain in contact with the ship hull, even when the ship is moving, and a traction system, such as wheels or tracks, that enable the vehicle to traverse the hull. The vehicle includes an inspection sensor, such as a video camera, ultrasound probe, sonar, or other sensing system, and may include or be coupled to a storage medium, such as a hard disk or magnetic tape, for keeping a record of the inspection. The vehicle may be referred to as an underwater crawler vehicle to distinguish it from previously known ROVs that rely solely on impellers for movement, although it should be understood that the vehicle may utilize wheels, tracks, or other devices in its movement.

The record of inspection generated during the inspection may be retained onboard the inspected ship or elsewhere, such as encrypted and uploaded to a permanent repository located onshore. The data acquired during the inspection may be displayed in real-time or at some subsequent time, for review by a human inspector, either onboard the ship under inspection or by an inspector at a remote location. The information obtained during the inspection also may be compared to normative data for the class of ship being inspected to determine whether anomalies are present that require further attention.

The foregoing comparison process may be automated. In this case, if the comparison process identifies a potential anomaly, a signal may be sent to an analyst, such as an engineer or security specialist, to examine and interpret the data. The analyst may be local or remote, such as onboard the ship under inspection or remotely accessible via radio or satellite transmissions. The latter case enables a single analyst to concurrently review the data for numerous inspections.

In accordance with one aspect of the present invention, the topography of each ship's hull obtained during an inspection using the vehicle of the present invention may be entered into a database. If, during subsequent inspections, images and or other data recorded during any of those inspections vary beyond predetermined thresholds from historical data, e.g., by comparing current video images to historical images using image correlation software, a signal may be sent to the analyst. In this manner, the present invention makes the inspection process highly automated, and assists in pinpointing potential problems.

In accordance with a further aspect of the present invention, the vehicle may be configured to perform semi-automated inspections using a search profile, without a need for continuous real-time monitoring or control by a human operator. For example, given data regarding the dimensions of the hull, the vehicle may perform the search by following a predetermined route, thereby obviating the need for direct real-time control by an operator. When the predetermined route of the inspection is completed, the vehicle may return to a previously designated location to be recovered.

The vehicle also may comprise thrusters, impellers, and/or propellers to steer and maneuver the vehicle in the open water. These would enable the vehicle to reach an inspection target, such as a ship's hull, a dam, or other examination site.

In accordance with a another aspect of the present invention, an underwater crawler vehicle adapter system may be provided that comprises a vortex generator and a traction system, wherein the adapter system may be coupled to a commercially available ROV, such as those available from SeaBotix, Inc. of San Diego, Calif. In this regard, when the adapter system is uncoupled from the ROV, the ROV operates in a traditional manner in which its motion may be equally distributed in three dimensions and controlled primarily by thrusters, impellers, or similar propulsion devices. In contrast, when the adapter system is coupled to the ROV, the system's motion may occur predominantly in two dimensions as the system's movement is primarily controlled by the traction system. The system may still operate in a traditional manner controlled primarily by thrusters, impellers, or similar propulsion devices even with the adapter system coupled to the ROV.

Methods of using the underwater crawler vehicle of the present invention also are described.

### BRIEF DESCRIPTION OF THE DRAWINGS

The above and other objects and advantages of the present invention will be apparent upon consideration of the following detailed description, taken in conjunction with the accompanying drawings, in which like reference numerals refer to like parts throughout, and in which:

FIG. 1 illustrates previously known methods of conducting a hull inspection;

FIG. 2 is a perspective view of an illustrative embodiment of a vehicle of the present invention;

FIGS. 3A and 3B are, respectively, rear and bottom views of the vehicle of FIG. 2;

FIG. 4 is a simplified block diagram of components of the vehicle of FIG. 2;

FIGS. 5A and 5B depict an illustrative method of conducting a hull inspection in accordance with the principles of the present invention;

FIG. 6 is a schematic view of a system for conducting remote review of inspection data generated by an embodiment of the vehicle of the present invention;

FIG. 7 is a schematic view of a system for storing hull inspection records and comparing inspection data with previously saved data;

FIG. 8 is a flow chart of an illustrative method of using a vehicle of the present invention;

FIG. 9 is a perspective view of an illustrative embodiment of an ROV and an adapter system of the present invention in an uncoupled configuration;

FIG. 10 is a perspective view showing the ROV and adapter system of FIG. 9 coupled together.

### DETAILED DESCRIPTION OF THE INVENTION

The present invention is directed to an underwater crawler vehicle having a vortex generator, a traction system, and one or more sensors. The vehicle of the present invention advantageously may be used to inspect any of a number of submerged structures, such as dams, tanks, oil rigs, telecom cables, piers, and ship hulls. In addition, the vehicle of the present invention may be used to conduct inspections in other liquid environments, such as pipe interiors and exteriors.

Underwater structures may be examined for a variety of reasons. For example, is may be desired to examine the integrity of a ship's hull or the condition of a dam. Likewise, security concerns may lead to a desire to examine the hull of a ship prior permitting it to enter or leave a port.

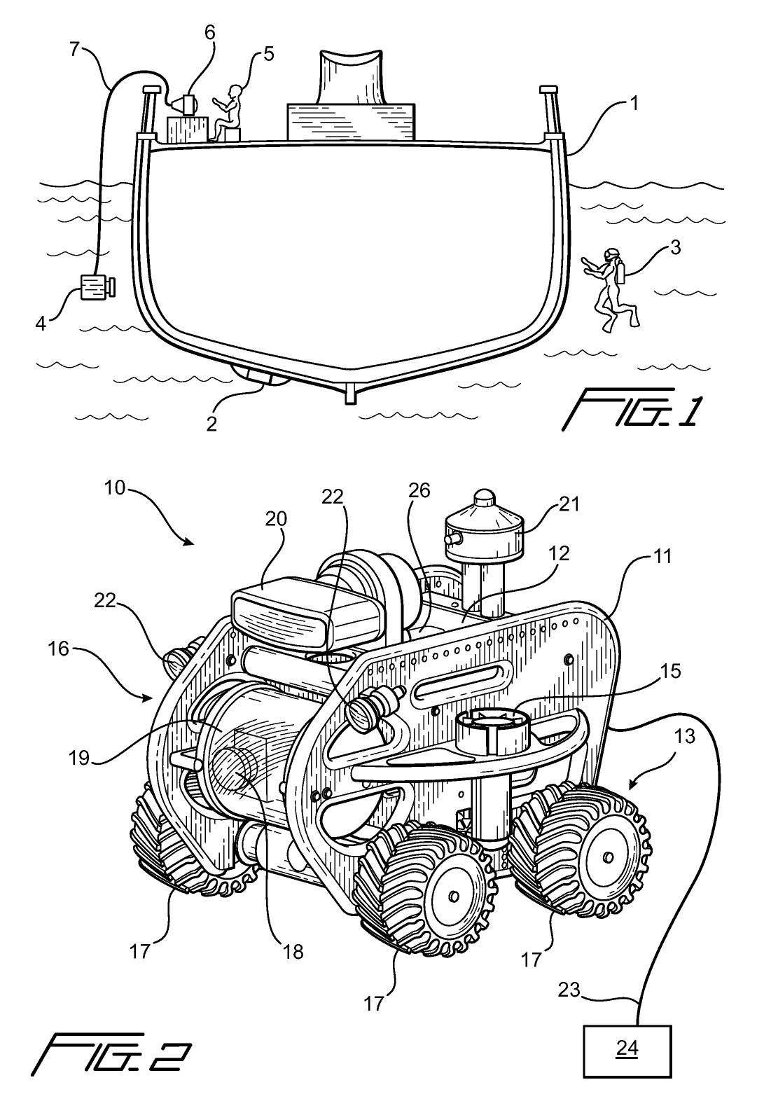

Historically, underwater inspections have been performed by divers, who provide visual assessments. FIG. 1 depicts vessel 1 onto which foreign object 2 has been placed. Object 2 may be a watertight container enclosing illegal drugs, weapons, or other contraband. During the inspection, diver 3 swims around vessel 1 in search of damage, corrosion, foreign objects, or other anomalies.

It will be appreciated that the thoroughness of the inspection by diver 3 is limited by a variety of human factors, including the physical endurance of the diver and the permissible period the diver may be submerged, as influenced ambient conditions (e.g., water temperature surge, clarity, etc.) and the draft of the ship. Other environmental factors such as the presence of currents, underwater obstacles, and potential hazards posed by other vessels also may limit the ability of diver 3 to conduct a thorough inspection. In addition, it is generally not possible for diver 3 to conduct an inspection while the ship is moving.

One previously known method of attempting to overcome the limitations associated diver inspection involves the use previously-known underwater ROV 4 having a steerable video camera. ROV 4 is controlled by trained operator 5 via terminal 6 and umbilical 7. Operator 5 directly and continuously controls and monitors the movement of ROV 4 using thrusters, impellers, or propellers attached to the exterior of the ROV. This method requires considerable operator concentration to steer and control movement of ROV 4, reducing the amount of time the operator can devote towards reviewing and interpreting sensory data, such as video images generated by the camera. In addition, the process of using the ROV may be tedious and lead to mistakes caused by inattention or boredom. Moreover, because previously known ROVs cannot keep pace with a moving ship, the inspection must be performed while the ship is stationary.

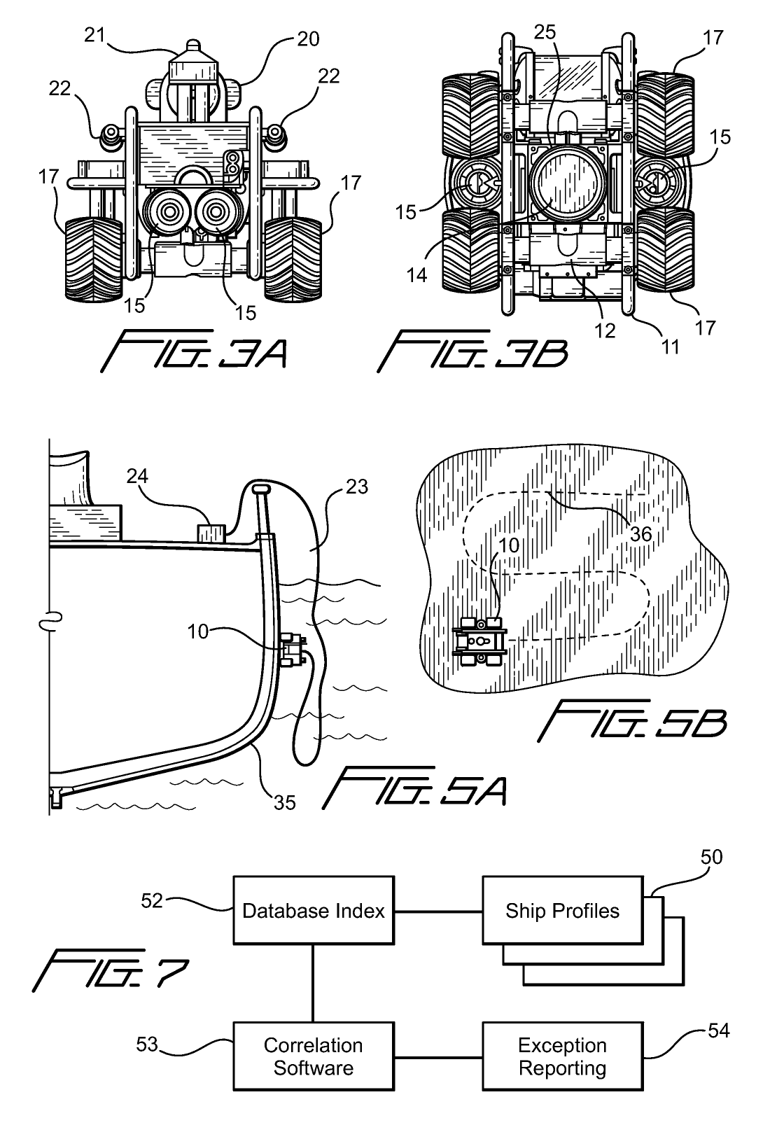

Referring to FIGS. 2 and 3, an illustrative embodiment of an underwater crawler vehicle constructed in accordance with the principles of the present invention is described. Vehicle 10 comprises frame 11 and chassis 12 that carry traction system 13, vortex generator 14, thrusters 15, and one or more sensor systems 16. Illustratively, traction system 13 comprises a plurality of motorized wheels 17. The one or more sensor systems may include video camera 18 mounted in waterproof housing 19, sonar system 20, and tracking system 21. Lights 22 are mounted on frame 11 to provide illumination for camera 18.

As depicted in FIG. 2, vehicle 10 is relatively compact in size, having a front profile of about one square foot, a length of about 2 to 2½ feet, and a weight of about 80 to 120 pounds. Vehicle 10 is connected via umbilical cord 23 to onboard console 24, which provides power to the vehicle, and a two-way data communication link. Alternatively, vehicle 10 may communicate with onboard console 24 wirelessly.

Vortex generator 14 may be of the type described in U.S. Pat. No. 6,619,922 to Illingworth et al. (hereby incorporated by reference) and includes an impeller that draws water through aperture 25 disposed in the underside of vehicle 10 (see FIG. 3B) to create a low pressure region and ejects the water through outlet 26 disposed in the top surface of the device. The low pressure region developed on the underside of the vehicle in combination with the thrust created by water expelled through outlet 26 creates a downforce relative to the vehicle that holds the vehicle against the inspection target, e.g., the ship hull. For example, if vehicle 10 is oriented with wheels 17 against the hull, activation of the vortex generator creates a pressure differential that induces the vehicle into increased contact with the hull. Vortex generator 14 is selected so that it develops sufficient forces to keep vehicle engaged with the ship hull even when the ship is moving.

Traction system 13 may comprise motorized wheels 17 that are used to traverse the vehicle along the inspection target, e.g., from bow to stern along the ship hull. In the embodiments of FIGS. 2 and 3, each wheel 17 is coupled to an independently operable motor that is capable of forward or reverse motion. Vehicle 10 may be translated in the forward or reverse directions by driving wheels 17 concurrently in the forward or reverse direction. Vehicle 10 may be turned by driving the wheels in different speeds or directions and may be turned within its length by driving the wheels on one side of the vehicle in a direction opposite to the wheels on the other side.

Wheels 17 preferably comprise a resilient and durable rubber-like material capable of withstanding repeated exposures to seawater. Wheels 17 are sized to provide sufficient clearance between the underside of the vehicle and the hull so that the vehicle may pass over barnacles or unevenness on the exterior of the ship hull. In addition, wheels 17 are sized such that the vortex generator generates sufficient downforce to retain the vehicle in contact with the hull surface, even when the ship is moving.

Vehicle 10 preferably includes a plurality of thrusters 15 that enable the vehicle to maneuver through open water, such as when approaching and returning from a target vessel. In the embodiment of FIGS. 2 and 3, thrusters 15 are arranged to provide forward motion and vertical motion, and to roll the vehicle about its longitudinal axis. Additional thrusters may be included to provide additional degrees of translation or rotation. Additionally, vehicle 10 preferably has a slightly positive buoyancy so that it will ascend to the surface in the event of a malfunction.

In accordance with one aspect of the present invention, the vertical thrusters are offset. Accordingly, when vehicle 10 approaches an underwater surface oriented at an angle, the vertical thrusters may be differentially actuated to cause vehicle 10 to roll about its longitudinal axis. It is contemplated that thrusters 15 will be employed primarily upon transfer of the vehicle to the inspection site and during recovery. While the device is engaged with a ship hull, the vortex generator and traction system will be operative.

Sensor systems 16 carried by vehicle 10 are configured to provide one or more types of data regarding the hull, which data is communicated to the onboard console via umbilical cord 23. Illustratively, vehicle 10 includes steerable video camera 18 and sonar 20. Camera 18 is preferably suitable for high resolution imaging in low-light situations, which may be a commercially available Sony CCD or similar camera. Camera 18 preferably is disposed within optically clear watertight housing 19 formed, for example, of polycarbonate, acrylic or glass, which is in turn coupled to chassis 12. Camera 18 preferably is rotatable within housing 19 to provide a variety of perspectives. Housing 19 preferably provides a 180° field of view (i.e., from approximately straight down to straight up). It is contemplated that this configuration may provide 270° field of view when combined with a 90° view from the camera lens.

Vehicle 10 also may include tracking system 21 that assists in determining the location of the vehicle during the inspection. As described in greater detail below, data collected using sensor systems 16 is communicated to onboard console 24, which is located remotely from vehicle 10. Although onboard console 24 may be located onboard a vessel undergoing examination, it may be located on another vessel or another location. The data then may be reviewed in real-time or transmitted via a data link to an onshore facility for review and analysis.

Frame 11 generally comprises port and starboard panels joined to watertight chassis 12 via a plurality of crossmembers. Frame 11 preferably comprises a hardened synthetic material, such as a ballistic plastic, that is capable of withstanding exposure to a marine environment and changes in pressure with little to no loss of strength and rigidity. Frame 11 may include one or more openings that facilitate lifting and carrying the vehicle and/or access for the hooks for a crane or hoist.

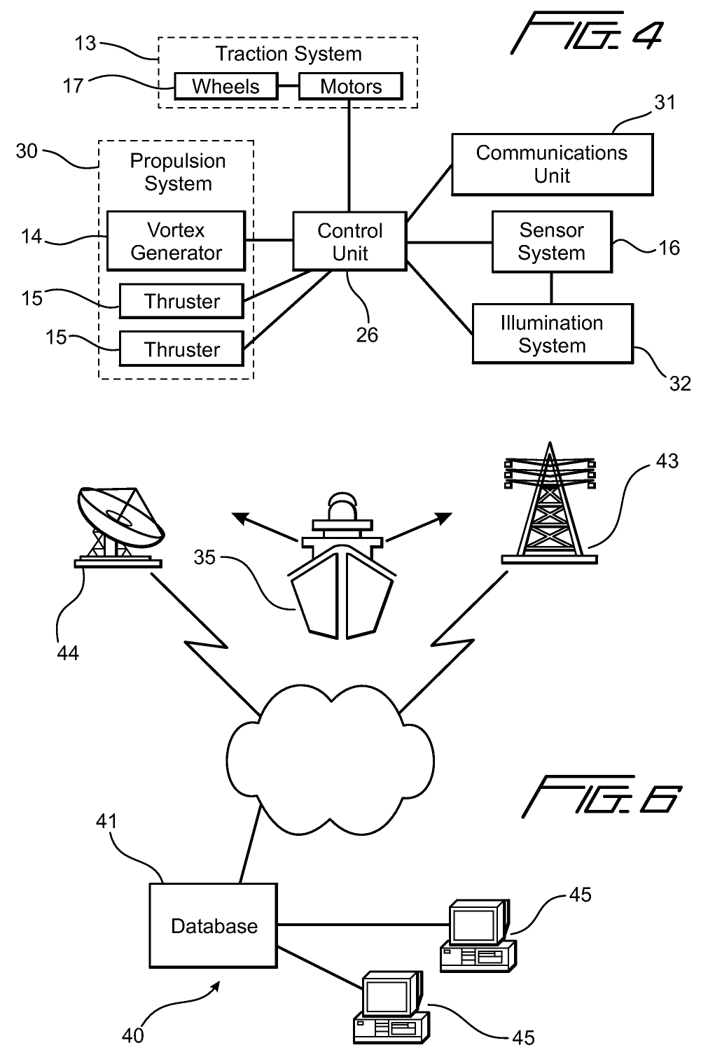

Referring now to FIG. 4, a schematic of the primary systems of vehicle 10 is described. Control unit 26, which may comprise a microprocessor or application specific integrated circuit, controls the activities of vehicle 10 responsive to commands received from onboard console 24. Control unit 26 controls operation of the other systems of the vehicle 10, including traction system 13, vortex generator 14, thrusters 15 and sensors 16.

In a preferred embodiment, traction system 13 comprises independently operable electric motors coupled to each of wheels 17. Motors 13 may be operated in the forward or reverse directions to move vehicle 10 forward or rearwards. As noted above, the wheels on opposite sides of the vehicle may be driven in different speeds or directions to cause the vehicle to turn. Alternatively, a track system or other form of locomotion may be substituted for wheels 17.

Propulsion system 30 comprises vortex generator 14 and thrusters 15. Vortex generator 13, which causes the vehicle to incur increased contact the inspection target, preferably comprises an impeller driven by an electric motor sealed within watertight chassis 12. Thrusters 15 comprise individually operable propellers driven by electric motors that enable maneuvering of the vehicle in an open water environment. Although four thrusters are depicted in the embodiment of FIGS. 2 and 3, a greater or lesser number may be included as appropriate for a specific application.

Sensor system 16 is used to collect data, and as described above may comprise one or more of sonar, a video camera, thermal detectors, Geiger counters, magnetometers, or other such devices. It may be desirable for sensor system 16 to comprise different types of sensors, such as a camera and a sonar unit, so that different types of data may be collected. Analyzing collected data may enhance the probability of locating an anomaly. In accordance with one aspect of the present invention, sensor system includes a sonar unit, such as the commercially available Micron system, manufactured by Tritech International.

It will be appreciated that data obtained by sensor system 16 may be transferred to communications unit 31 for transmission to onboard console 24. As further described below, onboard console 24 may be configured to perform an automated analysis of the data received from sensor system 16, and trigger an alert if a detected reading exceeds a predetermined threshold value.

Illumination system 32 is an optional component, and is provided, for example, when a video or still camera is employed to obtain image data. Illumination unit 17 may comprise LEDs, Quartz Halogen lamps, infrared lamps, or other light sources. In a preferred embodiment, illumination system 17 is configured to track the movement of steerable camera 18, thereby directing the illumination to the site under examination by the camera.

Communications unit 31 transfers data to and from vehicle 10, and may comprise hardware and software to facilitate the transfer of data from the various subsystems to control unit 26 and onboard console 24. Communications unit 31 comprises an umbilical interface, with associated hardware and software coupled to control unit 26. This configuration enables vehicle 10 to transmit and receive information via umbilical cord 23 to onboard console 24. Onboard console may compare the data generated by the sensor system to normative values of a historical record, and generate an alert if an anomaly is discovered. Alternatively or in addition to the use of umbilical cord 23, vehicle 10 may receive commands wirelessly from onboard console 24, and communications unit 31 in addition may comprise a wireless transceiver.

Optionally, communications unit 31 may further include tracking system 21 such as a hydrophone array or other device that may be used for determining the vehicle position. This feature allows monitoring of vehicle 10, and may be beneficial to determine the progress of vehicle 10 as it is operated in an autonomous mode and following a predetermined search pattern. It will be appreciated that other optional components may be added to vehicle 10, such as grabbers, ultrasonic thickness gauges, laser scalers, tilt sensors, accelerometers, depth sensors, and other devices. The sensors optionally may be modular and/or interchangeable.

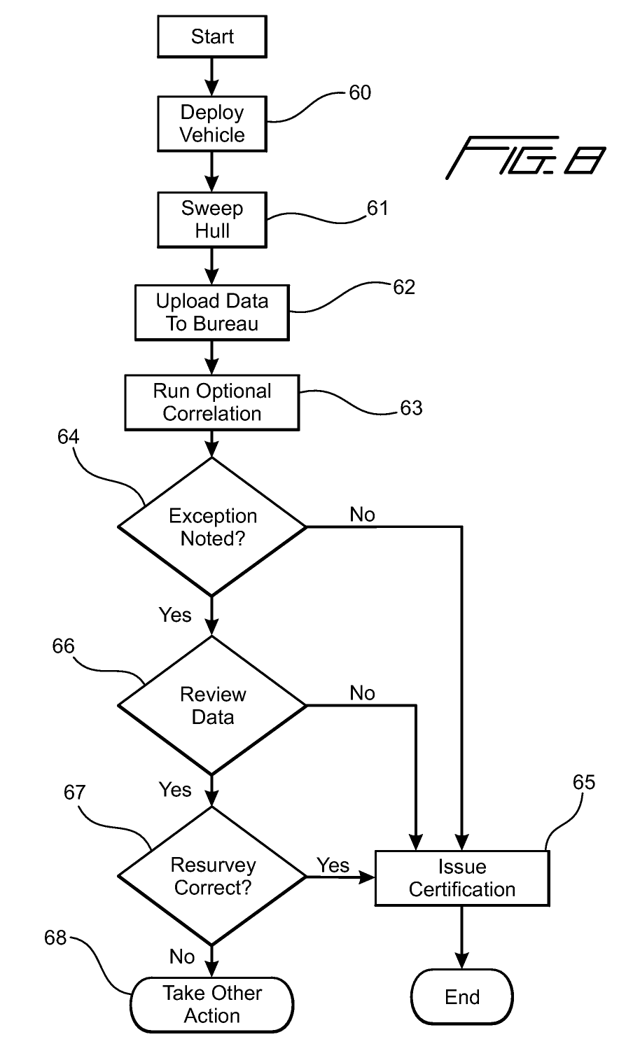

Referring now to FIGS. 5, a method of using vehicle 10 is described. Vehicle 10 may be coupled to onboard console 24 via umbilical 23, which transmits data and power as vehicle 10 moves about on submerged surface 35. Here, submerged surface 35 comprises the hull of a ship. Onboard console 24 may comprise a microprocessor-based control, an input device (e.g., keypad and joystick), and a monitor. Onboard console also may provide a communications link, e.g., via satellite, with an onshore processing facility.

First, vehicle 10 is deployed into the water and is guided using thrusters 15 to a position in proximity to the inspection site. Once in proximity to the site, the vertical thrusters are operated to roll the vehicle on its side. Vortex generator 14 then is activated, causing the vehicle to experience contact with the hull of the ship. Onboard console 24 may then instructs the vehicle to initiate a preprogrammed inspection path, such as a series of linear paths in alternating directions. Because the path may be preprogrammed, the vehicle 10 may be operated with minimal monitoring.

As vehicle 10 follows its inspection path, sensor system 16 acquires one or more types of data, including sonar, ultrasound or infrared scans, audio records or video images. The collected data may be transmitted to onboard console 24 for analysis and storage, and/or may be stored onboard vehicle 10 or some other location. Onboard console 24 may be programmed to direct autonomous or semi-autonomous operation of vehicle 10. Alternatively or in addition, vehicle 10 may be programmed to direct autonomous or semi-autonomous operation. Vehicle 10 may be programmed to follow a predetermined search pattern, based on the nature of the submerged surface 35, or other factors.

For example, vehicle 10 may be programmed to follow path 36 that involves traversing the hull from the stern to the bow at a constant depth, then decreasing the depth and making a return pass, thereby surveying the entire portion of the ship below the waterline as depicted in FIGS. 5A and 5B. Advantageously, providing autonomous operation of vehicle 10 obviates the need for operator to continuously monitor and control the movement of the vehicle during performance of the inspection.

Referring now to FIG. 6, another aspect of the present invention is described in which onboard console 24 transmits data generated by sensor system 16, for example, via satellite to an onshore facility 40 for review and analysis. Onshore facility 40 may be in communication with a plurality of vehicles 10 of the present invention. If deployed at the entrance of a harbor, the onshore facility may attend to multiple inspections concurrently by a plurality of vehicles 10 with a relatively few operators. It will be appreciated that instead of transmitting data to onshore facility 40, onboard console 24 (or even vehicle 10) may transmit data to one or more remote locations that may include ships, satellites, planes, stationary locations or other locations. For purposes of explanation, and without limitation, the scenario in which onboard console 24 communicates with onshore facility 40 will be considered.

In particular, data collected by sensor system 16 of vehicle 10 is communicated to onboard console 24, which then may transmit that data to database 41 located at an onshore processing facility. Of course, in other embodiments, vehicle 10 may communicate with database 41. One manner of effectuating this communication is by establishing a connection with electronic communication network 42, including radio 43 and satellite 44. Communication between onboard console 24 and database 41 preferably is two-way, thereby allowing onboard console 24 to obtain information regarding the ship under examination. This information may be employed in the anomaly identification process, discussed below.

Database 41 of onshore facility may contain normative data regarding the hull configuration for a specific ship, or class of ships, which may be transmitted to onboard console 24. Data generated from the current inspection may be compared to this normative data to identify anomalies. Alternatively, analysis of the data generated during the current inspection may be transmitted to the onshore processing facility and analyzed at the onshore facility.

In the event that an anomaly is discovered, the onboard console or remote processing facility may pause the inspection and generate an alert. An inspector associated with the onboard console, or present at monitoring console 45 at onshore facility 40, then may direct the vehicle to gather additional information about the identified anomaly. Once this additional information is obtained, the vehicle may resume its automated inspection pattern.

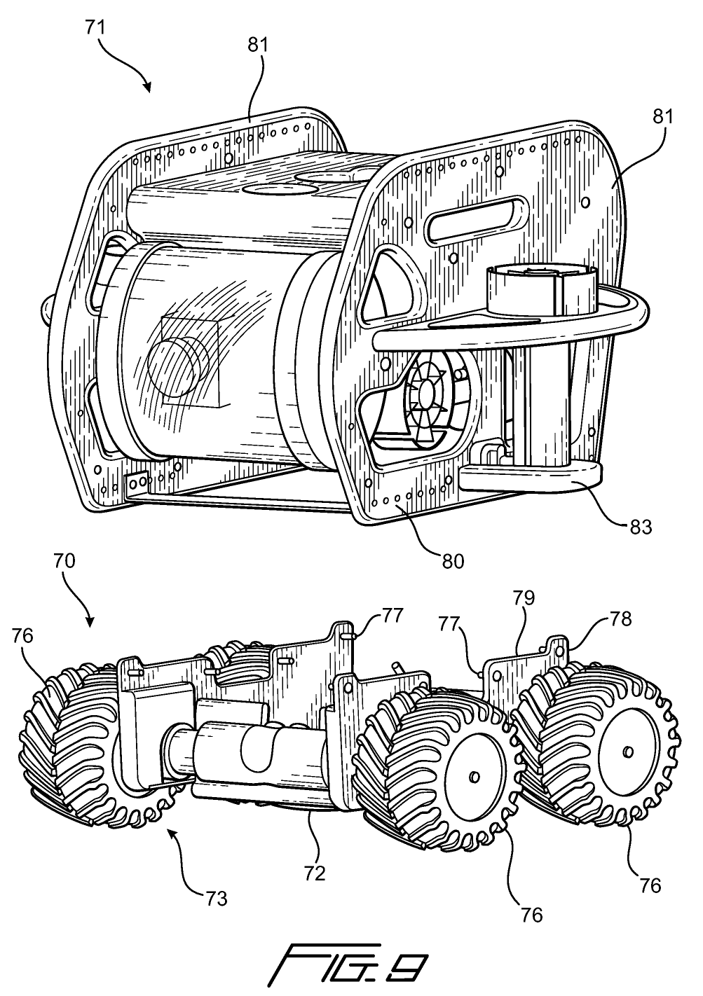

With respect to FIG. 7, a method of detecting an anomaly using the system depicted in FIG. 6 is described. It will be appreciated that the efficiency of inspections may be improved by automating the anomaly identification process. This may be accomplished by creating database 50 that contains information for specific ships, and in which additional records are generated during subsequent inspections. For security reasons, it would be preferable that database 50 be maintained at a secure onshore facility. Records stored in database 50 are received from the onboard consoles during, or at the conclusion of, inspections performed by vehicle 10.

A method of using these records in which data generated during a current inspection is compared to historical data to detect an anomaly is now described in the nonlimiting context of a ship's hull inspection. Sensor data generated for a current inspection is transmitted from vehicle 10 to onboard console 24. Next, database index 51 located at the onshore facility is accessed to locate records for the ship being inspected. This location may be facilitated based upon information input by an input device at the onboard console or onshore facility, for example, the hull number of the ship to undergo inspection. The most recent historical record 52 for the ship is then located and transmitted to the onboard console (or readied at the onshore facility if the analysis is conducted at that location).

For example, there may be historical data on the exact ship or examination site that was obtained from architectural drawings or previous examinations. Other data that may be helpful includes data from similar examinations, such as ships of a certain class. Once the desired historical data 50 is located, an analysis routine, e.g., correlation software 53, is run to compare the data generated during the current inspection to the historical record. For example, if the historical record includes a video image of the hull, image correlation software may be used to determine whether there have been any significant variations in the appearance of the hull since the last inspection. If any variation observed by the analysis routine exceeds a predetermined threshold, an alert may be generated, as indicated by exception reporting routine 54, so that further information regarding the potential anomaly may be obtained and/or corrective action taken. Such an analysis routine may be facilitated by data compilation and manipulation, including but not limited to three-dimensional representations of the hull based on historical data that may be compared to data received during the current inspection.

FIG. 8 illustrates a method of examining a submerged surface. While this methods is described in the context of inspecting the hull of a ship, it should be appreciated that the method of the present invention may be used for examining any number of submerged structures, such as dams or bridge pylons.

At step 60, vehicle 10 is deployed at the inspection site. This step involves placing vehicle 10 in the water in proximity to the hull of the ship to be inspected, and then inducing the vehicle against the hull by actuating the vortex generator. At step 61, the hull of the ship is swept. As described above, vehicle 10 may follow a predetermined path while collecting data using one or more sensors. The data is transmitted to the onboard console for analysis or alternatively transmitted to the onshore facility.

At step 62, the inspection data is transmitted to the onshore facility for analysis. At step, 63, an analysis of the current inspection data may be performed using either normative or historical data for that hull. As a result of the analysis performed by the analysis routine, an anomaly is either flagged or not, as indicated by decision box 64. If no anomaly is detected, a certification or finding is issued at step 65 that no anomaly was detected and the process ends.

Alternatively, if an anomaly is flagged during the analysis process, an alert is generated that notifies an inspector (either onboard the ship or at the onshore facility) to take investigative or corrective action at step 66. For example, the alert may be communicated to an inspector, who may further analyze the data based on education, experience, and/or by using additional resources that are available. In the event that the inspector finds that the data is not abnormal, or can otherwise be explained, the alert may be cleared and a result is issued at step 65, which may be a certification or finding.

If the inspector concludes that the data is not normal or explainable, the inspector may order that the anomaly be resurveyed in step 67. If the resurvey of at step 69 provides results that reveal an explanation for the anomaly, then a certification may be issued and the process concludes at steps 65. Otherwise, other appropriate corrective action may be taken as necessary, such as damage control, bomb disposal, or confiscation of contraband, at step 68.

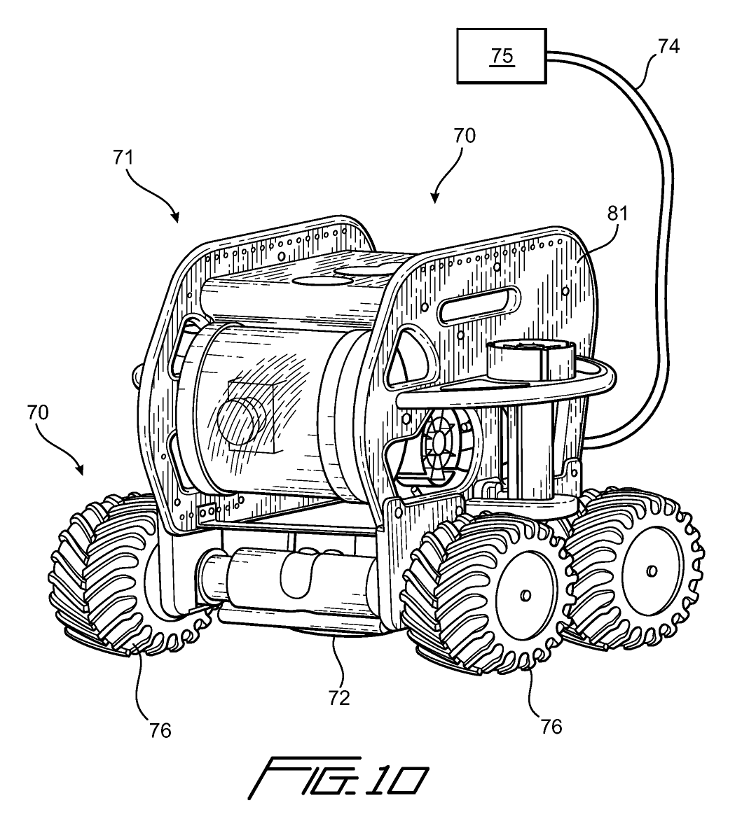

Referring now to FIGS. 9 and 10, another embodiment of the present invention is described. Here, the invention is embodied as adapter 70 that may be selectively coupled to ROV 71 or other apparatus having sensory devices. ROV 71 may be a commercially available ROV, such as available from SeaBotix, Inc., of San Diego, Calif. Adapter 70 may be selectively coupled to ROV 71 to provide ROV 71 with some of the features of vehicle 10, described in detail above.

In particular, adapter 70 preferably is equipped with vortex generator 72 and traction system 73, similar to vortex generator 14 and traction system 13 described above. In an embodiment of the present invention, when adapter 70 is coupled to ROV 71, vortex generator 72 and traction system 73 are coupled to an energy source on ROV 71. In other embodiments, one or both of vortex generator 72 and traction system 73 may be coupled to another source of energy, such as an onboard energy source or via umbilical cord 74 to remote energy source 75. The energy source provides power for traction system 73 and is used to drive motorized wheels 76.

Adapter 70 is coupled to ROV 71 by a plurality of connector members 77 that may pass through receptacles 78 in adapter frame 79 and through receptacles 80 in ROV frame 81. Connector members 77 may comprise bolts, screws, pins, cotter pins, shafts, or other known devices used for coupling or attachment purposes. In other embodiments, the coupling between adapter system 70 and ROV 71 may include magnets, braces, brackets, or other coupling devices.

When adapter 70 is coupled to ROV 71, the combined unit 82 may have features of each individual device. For example, combined unit 82 may move about in the open water using the propulsion devices of ROV 71, such as thrusters 83 or similar devices. Likewise, combined unit 82 may use vortex generator 72 to induce combined unit 82 into greater contact with a ship's hull or other underwater surface, facilitating the use of traction system 73 to translate over that surface. Accordingly, it will be appreciated that combined unit may predominantly operate under control of the propulsion system of ROV 71 for delivery to a selected inspection location, and may then predominantly operate under control of the propulsion system of adapter 70 during an inspection.

Although preferred illustrative embodiments of the present invention are described above, it will be evident to one skilled in the art that various changes and modifications may be made without departing from the invention. It is intended in the appended claims to cover all such changes and modifications that fall within the true spirit and scope of the invention.

What is claimed is:

1. Apparatus for inspecting a surface in a fluid environment, the apparatus comprising:
a vehicle having a chassis;
a vortex generator coupled to the chassis and configured to engage the vehicle to the surface; and
a traction system disposed on the chassis and configured to translate the vehicle along the surface.

2. The apparatus of claim 1 further comprising a sensor disposed on the chassis for sensing a parameter.

3. The apparatus of claim 2 further comprising a control unit disposed within the chassis for coordinating operation of the vortex generator, traction system and sensor.

4. The apparatus of claim 1 further comprising a plurality of thrusters for maneuvering the vehicle through the fluid environment during approach to the surface.

5. The apparatus of claim 3 further comprising a console in communication with the vehicle.

6. The apparatus of claim 5 wherein the vehicle further comprises a communication unit for transmitting data to the console.

7. The apparatus of claim 6 wherein the console transmits data generated by the sensor to a remotely located processing system for analysis.

8. The apparatus of claim 5 wherein the control unit is configured to receive commands from the console.

9. The apparatus of claim 5 wherein the control unit is configured to receive commands from a remotely located processing system.

10. The apparatus of claim 7 wherein the data transmitted to the remotely located processing system is stored in a database to form a historical record.

11. The apparatus of claim 10, further comprising an analysis routine, the analysis routine programmed to compare data generated by the sensor during a current inspection to the historical record.

12. The apparatus of claim 11 wherein the analysis routine is further programmed communicate an alert if the data from the current inspection varies from the historical record by more than a predetermined amount.

13. The apparatus of claim 1 wherein the traction system comprises a plurality of motorized wheels.

14. The apparatus of claim 13 wherein each of the motorized wheels is driven by an independently operable motor.

15. A method of inspecting a surface submerged in a fluid environment, the method comprising:
providing a vehicle having a chassis, a vortex generator coupled to the chassis and configured to induce the vehicle against the surface, a traction system disposed on the chassis and configured to translate the vehicle along the surface, and a sensor;
deploying the vehicle in proximity to the surface;
activating the vortex generator to engage the vehicle against the surface;
actuating the traction system so that the vehicle traverses the surface; and
generating inspection data with the sensor.

16. The method of claim 15 further comprising interpreting the inspection data to identify an anomaly.

17. The method of claim 16 further comprising transmitting the inspection data to a remote location, wherein interpreting the inspection data to identify an anomaly comprises interpreting the data at the remote location.

18. The method of claim 17 wherein the remote location includes a historical record generated during a prior inspection of the surface and interpreting the inspection data to identify an anomaly comprises comparing inspection data from a current inspection to the historical record.

19. The method of claim 18 further comprising transmitting instructions from the remote location to the vehicle to control actuation of the traction system.

20. The method of claim 15 further comprising, upon the detection of an anomaly, triggering an alert.

21. Apparatus for movement in a fluid environment, the apparatus comprising:
a frame assembly;
a vortex generator coupled to the frame; and
a traction system coupled to the frame.

22. The apparatus of claim 21 wherein the frame is adapted to be coupled to an ROV.

23. The apparatus of claim 22 wherein the traction system further comprises a plurality of wheels.

24. The apparatus of claim 23 wherein at least one wheel is operable independently of at least one other wheel.

25. The apparatus of claim 24 further comprising an integrated power source.

26. The apparatus of claim 24 wherein the apparatus is adapted to be coupled to a remote power source.
